(19) United States
(12) Patent Application Publication
(10) Pub. No.: US 2026/0093949 A1
(43) Pub. Date: Apr. 2, 2026

(54) MULTI-STAGE DIGITAL PERCEPTRON ARCHITECTURE

(71) Applicant: The Board of Regents for the Oklahoma Agricultural and Mechanical Colleges, Stillwater, OK (US)

(72) Inventor: Brett Colton Mathis, Stillwater, OK (US)

(21) Appl. No.: 19/410,728

(22) Filed: Dec. 5, 2025

Related U.S. Application Data
(63) Continuation of application No. PCT/US24/33427, filed on Jun. 11, 2024.
(60) Provisional application No. 63/508,190, filed on Jun. 14, 2023.

(51) Int. Cl. G06N 3/04; G06F 1/04; G06F 7/544

(52) U.S. Cl. CPC G06N 3/04; G06F 1/04; G06F 7/5443

(57) ABSTRACT

Disclosed herein is a modular perceptron comprising a first and second n-input wide multiplexor for selecting input and weight values from n-input wide numeric and weight vectors, respectively. First and second registers receive the selected values, which are multiplied by a multiplier to generate a product. Counter logic circuitry controls the multiplexors and a counter to iterate through the input and weight values. A product and linear combination adder generates a sum output based on the product and a value from a third multiplexor. The sum is stored in a third register and processed by an activation function to generate an activation output, which is stored in a fourth register as a perceptron output. A base clock generates a signal for the fourth register, while a sub clock generates a higher frequency signal for the other registers based on the propagation delay from the multiplier input to the adder output.

### CROSS-REFERENCE TO RELATED APPLICATIONS

The present application is a continuation application claiming priority to PCT/US24/33427 filed on Jun. 11, 2024 which claims priority to U.S. Provisional Application 63/508,190, titled “Multi-stage Digital Perceptron Architecture” filed on Jun. 14, 2023, the entire content of which is hereby expressly incorporated herein in its entirety.

### STATEMENT OF FEDERALLY SPONSORED RESEARCH

Not Applicable.

### BACKGROUND

Neural Networks have become a major fixture of computational research in recent years, especially with the advent of large language models and their implementation, such as ChatGPT. Historically, most neural networks are entirely trained and executed in software, prominently in software API's such as TensorFlow™ (Google, Inc., Mountain View, CA, USA) and PyTorch™ (The Linux Foundation, San Francisco, CA, USA). This has allowed neural networks to become easy to develop and therefore ubiquitous in many sub-fields, such as image processing or language modeling. However, by limiting the majority of neural network development to software, substantial hardware performance requirements continue to exist for quickly training and using neural networks. Most neural networks are trained on specialized hardware processors designed for quick floating-point arithmetic, GPU's. Alternatively, networks with more extreme performance requirements will use ASIC devices with specialized Fused-Multiply-Add circuits in order to keep data propagation time to a minimum.

### SUMMARY

Therefore, a need exists to reduce the level of abstraction between neural network development and hardware, by creating a modular architecture that can be used to generate neural networks directly in hardware.

As disclosed herein, a new architecture for implementing perceptrons (e.g., perceptron architecture), the building blocks of neural networks, and how to translate existing software networks into hardware is described. By translating these networks into hardware, exceptional performance benefits can be realized due to the parallelism hardware implementations can achieve. Instead of being limited to the number of parallel data pathways present on a GPU or ASIC device, neural networks implemented directly can execute layers entirely in parallel. This significantly increases the throughput of a given network, since the only sequential execution is done between network layers, effectively leaving a datapath-propagation time proportional to the number of layers present and the layer's sparsity, instead of the number of perceptrons.

Antithetical to most high-performance circuit design, the perceptron architecture disclosed herein aims to reduce both area and power requirements for an individual perceptron for the largest number of cases. This reduction is prioritized over delay, since high-speed datapaths are typically power hungry, and the number of perceptrons in a given network is very large. To maintain the feasibility of implementing a neural network in hardware, power consumption is a concern. However, since the parallel execution of hardware networks provides a significant performance advantage over software execution, a slower critical path in a given perceptron is acceptable over a highspeed architecture. Additional unique performance challenges are present in implementing neural networks in hardware, due to power requirements of some operations, such as nonlinear activation functions and subsampling.

The problem of implementing perceptron and translating existing software networks into hardware is solved by the systems and methods herein disclosed. The systems and methods include a modular perceptron, comprising: a first n-input wide multiplexor operable to receive an n-input wide numeric vector having multiple input values and operable to select a particular input value of the multiple input values of the n-input wide numeric vector; a second n-input wide multiplexor operable to receive an n-input wide weight vector having multiple weight input values and operable to select a particular weight value of the multiple weight input values of the n-input wide weight vector; a first register operable to receive the particular numerical value from the first n-input wide multiplexor; a second register operable to receive the particular weight value from the second n-input wide multiplexor; a numerical and weight multiplier operable to perform a multiplication operation on the particular numerical value and the particular weight value to generate a product signal; a first multiplexor operable to receive the product and select between the product signal and zero as a first output; a counter operable to iterate on a scale of 1 from 0 to n−1 to generate a counter value; a second multiplexor operable to select between the counter value and zero as a second output; a counter logic circuitry configured to receive a global reset, to send the counter value to the first multiplexor to cause the first n-input wide multiplexor to select the particular input value; to send the counter value to the second multiplexor to cause the second n-input wide multiplexor to select the particular weight value, to selectively send a first reset value to the first multiplexor; to selectively send a second reset value to the second multiplexor; and to send the counter value to the counter to cause the counter to iterate; a product and linear combination adder operable to generate a sum output based on the first output of the first multiplexor and a third output of a third multiplexor; a third register operable to store the sum output of the product and linear combination adder and generate a sum output signal; the third multiplexor operable to receive the sum output signal from the third register, to select between the sum output signal and zero as a selected value, and to send the selected value to the product and linear combination adder as the third output; a non-linear activation function circuitry coupled to the third register and operable to receive the sum output signal and to generate an activation output; a fourth register operable to receive the activation output from the non-linear activation function circuitry and generate a perceptron output; a base clock circuitry configured to generate a base clock signal having a first frequency, the base clock signal being provided to the fourth register; and a sub clock circuitry configured to generate a sub clock signal having a second frequency within a range from n-times higher than the first frequency to an upper value based on a critical propagation delay between an input of the numerical and weight multiplier to the sum output of the product and linear combination adder, the sub clock signal being provided to the first register, the second register, and the third register.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques including methods, apparatus, systems, and computer program products are described.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of a neural network having a linear layer constructed in accordance with the present disclosure.

FIG. 2 is an architecture diagram of an exemplary embodiment of a modular perceptron constructed in accordance with the present disclosure.

FIG. 3 is an architecture diagram of an exemplary embodiment of a conditional perceptron constructed in accordance with the present disclosure.

FIG. 4 is a diagram of an exemplary embodiment of a linear layer constructed in accordance with the present disclosure.

FIG. 5 is a diagram of an exemplary embodiment of a multidimensional layer having a plurality of perceptrons constructed in accordance with the present disclosure.

FIG. 6 is a functional diagram of an exemplary embodiment of the window function of FIG. 5 constructed in accordance with the present disclosure.

### DETAILED DESCRIPTION

Before explaining at least one embodiment of the inventive concept(s) in detail by way of exemplary language and results, it is to be understood that the inventive concept(s) is not limited in its application to the details of construction and the arrangement of the components set forth in the following description. The inventive concept(s) is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the presently disclosed inventive concept(s) shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification.

All patents, published patent applications, and non-patent publications mentioned in the specification are indicative of the level of skill of those skilled in the art to which this presently disclosed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the term “about” is used to indicate that a value includes the inherent variation of error for a composition/apparatus/device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

Software may include one or more computer readable instructions that when executed by one or more components cause the component to perform a specified function. It should be understood that the algorithms described herein (e.g., the mathematical model referred to in the attached document(s)) may be stored on one or more non-transitory computer readable medium. Exemplary non-transitory computer readable mediums may include random access memory, read only memory, flash memory, and/or the like. Such non-transitory computer readable mediums may be electrically based, optically based, and/or the like.

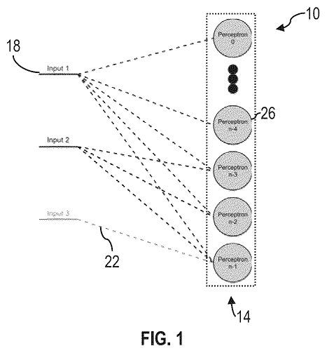

Referring now to FIG. 1, shown therein is a diagram of an exemplary embodiment of a neural network 10 having a linear layer 14 constructed in accordance with the present disclosure. The linear layer 14 generally comprises a plurality of inputs 18 having one or more connections 22 to one or more perceptrons 26. The neural network 10 may be considered a sparse, linear network layer because each input 18 is not coupled to every perceptron 26 of the linear layer 14.

Generally, a simple network, such as the neural network 10 shown in FIG. 1, configured of flat, linear layers 14 can be utilized for basic classification problems. Analysis of multidimensional data, such as images and video, can be completed by convolutional layers along with subsampling layers. Language prominent problems can be solved by layer recurrence, and some particularly nonlinear relationships can be modeled well by alternative structures. However, in nearly every neural network and its configuration, each layer is made of a fundamental computational unit called a perceptron 26. Each perceptron 26 performs two tasks: generating a linear combination of input and weight vectors and passing the linear combination through a nonlinear activation function, such as:

$$LinComb ( x , w , b ) = {\sum }_{i = 0}^{n} {x}_{i} * {w}_{i} + b and output = f ( LinComb ( x , w , b ) ) ;$$

$$where f ( x )$$

is an arbitrary nonlinear function and both x and w are input and weight vectors of the same size, and b is a bias used to backpropagate results of the layer output to this layer of the network, giving the perceptron 26 a form of feedback. The bias becomes part of the same linear combination as the input and weight vectors.

In one embodiment, both x and w can vary in size between perceptrons 26 in the same linear layer 14, which may be due to removing connections from previous layer outputs via a process called pruning. Pruning can lead to significant performance improvements in software network implementations, and sufficient pruning is prudent for hardware networks, specifically in regards to lowering power consumption. The activation function may be useful to find any nonlinear patterns in data given to the neural network 10, and without the activation function, most networks will have a poor quality relationship between input data and output. In some embodiments, the activation function may be implemented in circuitry, as described below.

In one embodiment, linear layers 14 may be a single column of perceptrons 26 that either get input directly from a previous layer, or as the input 18 of the neural network 10. Generally, linear layers 14 will start with each input signal connected to each perceptron 26 via connections 22. As the neural network 10 trains, unused connections 22 will be pruned (e.g., removed) and the linear layer 14 will go from fully-connected to a more sparse configuration as shown in FIG. 1.

In some embodiments, linear layers 14 may be used to connect different types of network layers or act as an output for a classification network type of neural network. Sequential linear layers 14 can be used to form more deep network structures, and can, in some embodiments, be used recursively for different learning algorithms.

In one embodiment, convolutional layers have many more moving parts than linear layers. Convolutional layers may be multidimensional and made of corresponding multidimensional arrays of perceptrons 26. A common form of convolutional layers includes two-dimensional convolutional layers used in processing images. In order to detect patterns in an input data array, e.g., the inputs 18, a sliding window function is convolved over available perceptrons 26.

In one embodiment, the window function may have a size, as well as an offset pattern used to move the window function. The size of the window function and the offset pattern may determine a total output size of the convolutional layer. Larger, more aggressive window patterns can capture bigger patterns in data, but at the expense of more layer outputs.

In one embodiment, subsampling layers may be used directly after convolutional layers to solve the problem of more layer outputs. The subsampling layers gather a number of results from a previous layer, and use a subsampling function to determine which of those results can be used as an output. Exemplary subsampling layers may include average pooling and max pooling layers, which find either an average value or a maximum value, respectively, of a given dataset subsample, and directly output that value.

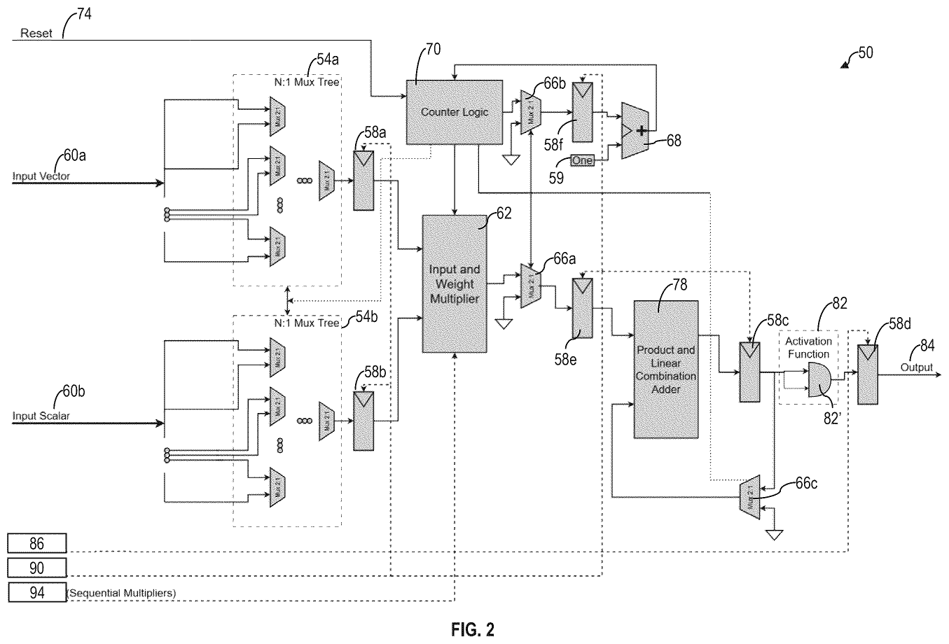

Referring now to FIG. 2, shown therein is an architecture diagram of an exemplary embodiment of a modular perceptron 50 constructed in accordance with the present disclosure. The modular perceptron 50 generally includes a first n-input wide multiplexor 54a and a second n-input wide multiplexor 54b. The first n-input wide multiplexor 54a may be communicably coupled to a first register 58a and the second n-input wide multiplexor 54b may be communicably coupled to a second register 58b.

In one embodiment, the first n-input wide multiplexor 54a may be constructed as an n-input wide multiplexor operable to receive an n-input wide numeric vector 60a having multiple input values and operable to select a particular input value of the multiple input values of the n-input wide numeric vector 60a. In one embodiment, the second n-input wide multiplexor 54b may be constructed as an n-input wide multiplexor operable to receive an n-input wide weight vector 60b having multiple weight input values and operable to select a particular weight value of the multiple weight input values of the n-input wide weight vector 60b.

In one embodiment, each of the n-input width multiplexors 54 may be a multiplexor tree comprising a plurality of 2-bit multiplexors, having two inputs and one output, arranged such that each value of the input vector 60a is provided to an input of a first rank of 2-bit multiplexors, and the output of each multiplexor of the first rank is provided to inputs of a second rank of 2-bit multiplexors, where each rank of 2-bit multiplexors includes half a number of 2-bit multiplexors of the prior rank. For example, a first rank may have 8 of the 2-bit multiplexors, each receiving two values of the input vector 60a and providing a first output, such that a second rank may have 4 of the 2-bit multiplexors where each input receives a particular one of the first outputs and generating a second output, a third rank may have 2 of the 2-bit multiplexors where each input receives a particular one of the second outputs and generates a third output, and a fourth rank may have one 2-bit multiplexor receiving the third output from each of the 2-bit multiplexors of the third rank and providing the particular input value.

In one embodiment, the first register 58a may receive the particular numerical value from the first n-input wide multiplexor 54a and the second register 58b may receive the particular weight value from the second n-input wide multiplexor 54b. The registers 58 may be communicably coupled to a multiplier 62 (e.g., a numerical and weight multiplier) operable to receive the particular numerical and weight values and to generate a product signal. The product signal may be sent to a first multiplexor 66a operable to receive the product signal and select between the product signal and a zero (e.g., ground) as a first output.

In one embodiment, the modular perceptron 50 further includes a second multiplexor 66b operable to select between the counter value and a zero (e.g., ground) as a second output provided to a sixth register 58f receiving a sub clock signal from a subclock circuitry 90 (described below), a counter 68, operable to iterate on a scale of 1 from 0 to n−1 to generate a counter value, e.g., based on the second output provided to the sixth register 58f that has been iterated up by a predetermined value 59 (i.e., one), and a counter circuitry 70 configured to receive a global reset 74 and the counter value of the counter 68 and to send the counter value to the first n-input wide multiplexor 54a and the second n-input wide multiplexor 54b. The first n-input wide multiplexor 54a may receive the counter value, which causes the first n-input wide multiplexor 54a to select the particular input value. The second n-input wide multiplexor 54b may receive the counter value which causes the second n-input wide multiplexor 54b to select the particular weight value. In one embodiment, the counter circuitry 70 may be further configured to selectively send a first reset value to the first n-input wide multiplexor 54a and a second reset value to the second n-input wide multiplexor 54b. In one embodiment, the counter circuitry 70 may be further configured to send the counter value to the counter 68 to cause the counter 68 to iterate.

In one embodiment, the counter circuitry 70 generates the counter value as a one-hot signal for each layer in the n-input width multiplexors 54. A one-hot signal includes a group of bits where only one bit can be high (1) and all other bits in the group of bits are low (0) at any given time. Generating the counter value as the one-hot signal may include, for example, creating a generate block, dividing the number of 2-bit multiplexor inputs of each n-input width multiplexor 54 by a multiple of 2 per iteration, and including a base case to conditionally catch odd-sized input vectors 60a as described by using a packed array and the counter value as an index described in Verilog (IEEE standard 1364) as

logic [n-1:0] [1-1:0] inputScalar;
assign inputW = inputScalar[countValue];

In this case, ‘1’ is the bit width given to each input or weight vector 60, and n is a total number of inputs or weights in each vector 60. Note that countValue should never exceed the size of the weight or input vectors 60. A reset signal given to the multiplier 62, used in sequential cases, should be set high when a subclock circuitry 90 is high, or when perceptron reset has been set high. The reset signal should return to a low value at the negative edge of the subclock signal. This can be implemented as follows, e.g., in Verilog:

always @ (posedge sclkl or posedge reset)
begin multReset = 1′b1; end
always @ (negedge sclkl or negedge sclkM)
begin multReset = 1′b0; end

The zero select signal used for resetting the counter value, multiplier product, and linear combination should be set high on global reset, and when the counter reference is not zero as follows, e.g., in Verilog:

assign countSel = reset & &(^{~}countValue);
assign multSel = reset & &(^{~}countValue);
assign linSel = reset & &(^{~}countValue);

In one embodiment, the modular perceptron 50 further includes a product and linear combination adder 78 operable to generate a sum output based on the first output of the first multiplexor 66a and a third output of a third multiplexor 66c. The sum output of the product and linear combination adder 78 may be received by a third register 58c configured to store the sum output and generate a sum output signal received by the third multiplexor 66c. In one embodiment, the product and linear combination adder 78 may have an architecture comprising one of: an RCA, a carry-skip, a carry-select, a prefix-tree, and a carry-look ahead architecture.

In one embodiment, the third multiplexor 66c may be operable to receive the sum output signal from the third register 58c, to select between the sum output signal and a zero (e.g., ground) as a selected value, and to send the selected value to the product and linear combination adder 78 as the third output.

In one embodiment, the modular perceptron 50 further includes a (non-linear) activation function circuitry 82 coupled to the third register 58c and operable to receive the sum output signal from the third register 58c to generate an activation output received by a fourth register 58d. The fourth register 58d may receive the activation output, store the activation output, and generate a perceptron output 84.

In one embodiment, the modular perceptron 50 further includes a base clock circuitry 86 configured to generate a base clock signal having a first frequency. The base clock signal may be provided to the fourth register 58d.

In one embodiment, the modular perceptron 50 further includes the subclock circuitry 90 configured to generate a sub clock signal having a second frequency within a range from n-times higher than the first frequency to an upper value based on a critical propagation delay between an input of the multiplier 62 to the sum output of the product and linear combination adder 78. The sub clock signal may be provided to the first register 58a, the second register 58b, and the third register 58c.

Generally, the modular perceptron 50 minimizes the amount of hardware required by controlling inputs into a single datapath. The base clock signal generated by the base clock circuitry 86, as well as at least one subclock signal generated by the subclock circuitry 90, are used to control when each input vector 60a and weight vector 60b are being used by the modular perceptron 50. The single datapath of the modular perceptron 50 begins with separate vectors for both weight values of the weight vector(s) 60b and input values of the input vector(s) 60a. Both weight and input vectors 60 are split into an n-input width multiplexor 54. In some embodiments, a signal of width log (2n) that uses the index of the signal to represent unique values, which may be referred to as a one-hot log 2n width control signal, selects the particular values (e.g., particular weight value and the particular input value), where n is the number of input values provided for each modular perceptron 50. These weight (e.g., scalar) and input values are moved into two registers, the first register 58a and the second register 58b, which are used as an input for the multiplier 62. The registers 58a-b use the subclock signal provided to cycle through each input provided to each n-input width multiplexor 54a-b. This means the period of the subclock signal is n-times faster than the base clock signal in order for all inputs to be cycled through to generate the perceptron output 84.

In one embodiment, a sequential multiplier is used in place of the numerical and weight multiplier of the multiplier 62, an additional subclock circuitry 94 may be provided to generate a second subclock signal, having a third frequency, provided to the sequential multiplier to generate the product for each vector and scalar input pair. This second subclock signal may have the third frequency be l/m times faster than the second frequency of the subclock signal, where l is the width of an input to the sequential multiplier and m is a number of product bits the sequential multiplier generates per clock cycle. In other words, the second frequency of the subclock signal may be determined as

$${f}_{second} = \frac{first frequency}{n}$$

and the third frequency may be determined by

$${f}_{third} = \frac{first frequency * m}{l} .$$

In some embodiments, the second frequency may be selected to have a range with an upper value of the third frequency divided by (2*m/l).

In one embodiment, once the product signal has been generated by the multiplier 62, the product signal is sent to a first multiplexor 66a which conditionally resets the product signal to zero on a multiplier reset. In some embodiments, the first output from the first multiplexor 66a is sent through a fifth register 58e controlled by the subclock signal. In this way, on the next cycle of the subclock signal, the first output (which may be the product signal) is added to the product and linear combination adder 78 for the modular perceptron 50, which is stored as in the third register 58c. This linear combination, i.e., the sum output signal of the third register 58c, is then sent through the activation function circuitry 82, which generates the activation output provided to the fourth register 58d, which is controlled by the base clock signal.

In one embodiment, the sum output signal and the product signal may have a predetermined format. The predetermined format may be one of: Posit, bfloat16, fixed-point, and IEEE754, or the like.

In one embodiment, an exemplary nonlinear activation function implemented in the activation function circuitry 82 is a Rectified Linear Unit (ReLU). The ReLU requires that the activation function circuitry 82 output is set to zero if the input to the activation function circuitry 82 is negative, otherwise the input is unchanged as the activation output. As shown, the ReLU is implemented as an AND gate 82′ using a most significant bit of the sum output signal of the third register 58c.

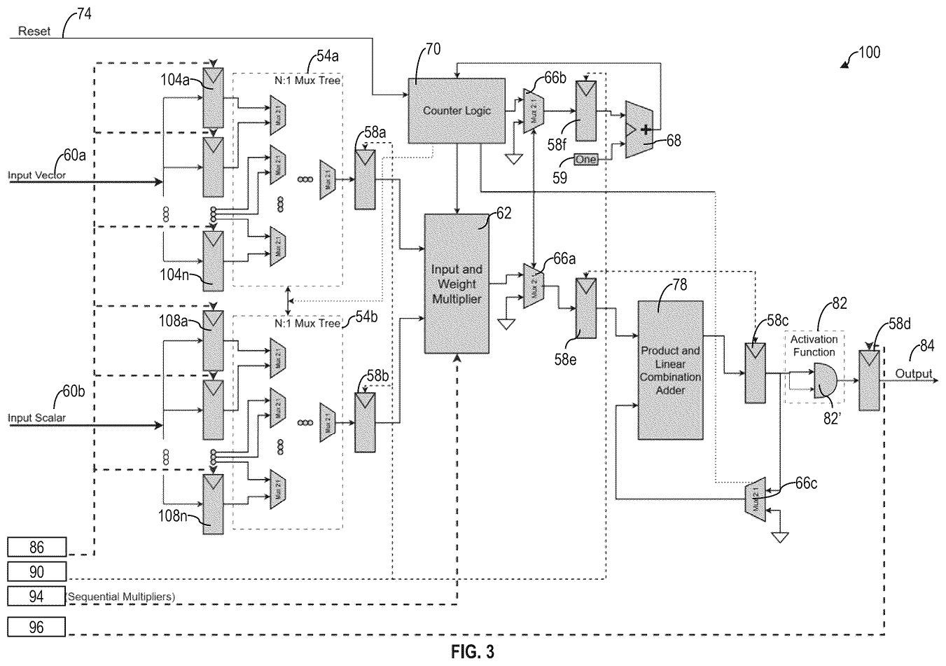

Referring now to FIG. 3, shown therein is an architecture diagram of an exemplary embodiment of a conditional perceptron 100 constructed in accordance with the present disclosure. The conditional perceptron 100 may be constructed in accordance with the modular perceptron 50 detailed above and shown in FIG. 2, with the exception that the conditional perceptron 100 further comprises a plurality of initial registers provided before the first n-input wide multiplexor 54a (shown as numerical registers 104a-n) and the second n-input wide multiplexor 54b (shown as weight registers 108a-n). In one embodiment, the conditional perceptron 100 may be preferred when it is desirable to keep input data stable, rather than depending on a previous layer or other input device. Providing the plurality of initial registers may, however, result in an increase in power consumption of the conditional perceptron 100 as the power consumption of the plurality of initial registers can be quite large. In one embodiment, the fourth register 58d may be considered redundant and may be omitted.

In one embodiment, when a particular layer of perceptrons needs to execute more quickly than layers, a combinational multiplier circuitry can be used in place of the multiplier 62, which may further increase the power consumption, possibly significantly, and should be used sparing if possible.

In one embodiment, when the perceptron may be used with an execution depth greater than one (i.e. the output of the perceptron is reused for subsequent linear combinations in the same perceptron), both the initial registers and fourth register 58d may be used, where the fourth register 58d of the conditional perceptron 100 is controlled by a deep clock circuitry 96 slower than the base clock. The deep clock circuitry 96 may generate a deepclock signal having a fourth frequency less than the first frequency. In this embodiment, the base clock signal may then be provided to the initial registers to move weight vectors 60b and input vectors 60a into the conditional perceptron 100, thereby allowing the linear combination adder 78 to further accumulate the first outputs and the third outputs. In this way, even though the initial registers have an increased power consumption, by dividing the linear combination output into additional cycles, when the number of values in the input vector 60a and the output vector are large (e.g., on a 32 nm process node, about 64 inputs at 16-bit width, for example; however, other factors may be used to determine whether the number of values is considered large, such as the process node being manufactured on, the power usage of the cells used to build register, and/or the libraries used), the conditional perceptron 100 may reduce power consumption when executing over an extended period of time.

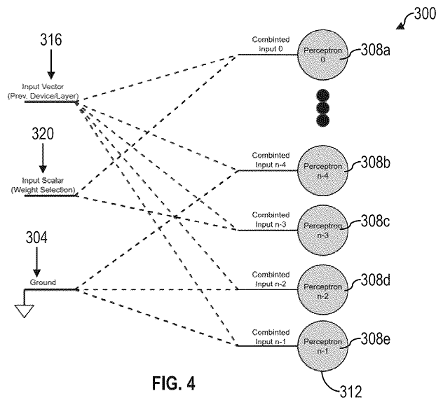

Referring now to FIG. 4, shown therein is a diagram of an exemplary embodiment of a linear layer 300 constructed in accordance with the present disclosure. The linear layer 300, as shown, remains fully-connected in structure, while each ground connection 304 reduces a size of a given perceptron 308, shown as being connected to perceptron 308b, 308d, and 308e. In the exemplary embodiment shown, the perceptrons 308 connected to the ground connection 304 may be removed entirely, e.g., via pruning.

In one embodiment, the linear layer 300 comprises a column vector 312 of perceptrons 308, and an input vector 316 of a size corresponding to a previous layer is given to each perceptron 308. During initial network generation, each column vector 312 of perceptrons 308 in the linear layer 300 is fully-connected, with each input vector 316 entry used while producing a perceptron's linear combination output. Using each perceptron's scalars vectors 320 as reference, individual input vectors 316 are removed for each zero-value found in the scalar vectors 320, thereby reducing an overall size of each perceptron 308 on a given linear layer 300.

In one embodiment, instantiations of each perceptron 308 are modular and parameterized, making the perceptrons 308 easy to resize. Bias terms may be given by values of the input vector 316 with a corresponding value of the scalar vector 320 of one. In one embodiment, if a neural network is already trained, finished scalar vectors 320 may be provided to remove the need for more than one generation cycle (e.g., iteration).

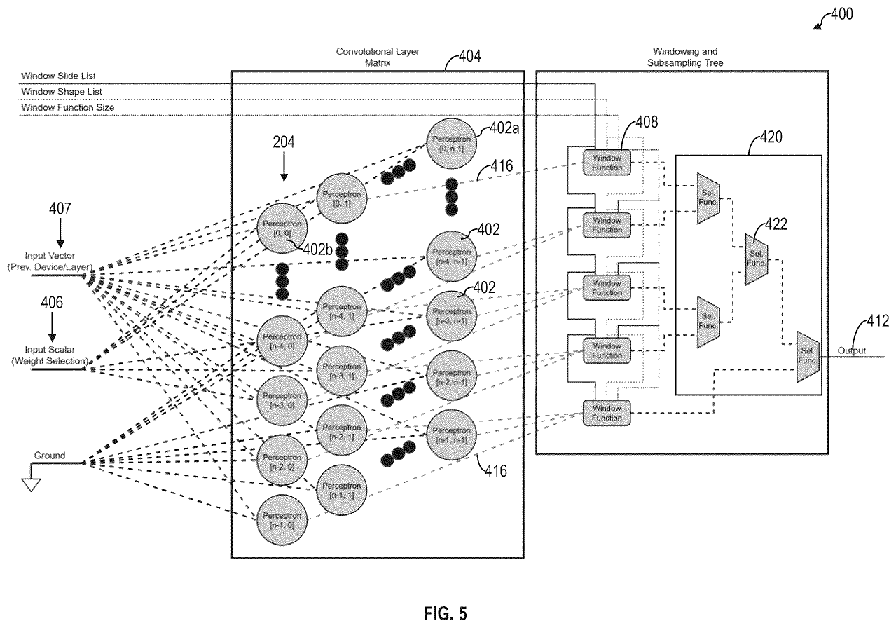

Referring now to FIG. 5, shown therein is a diagram of an exemplary embodiment of a multidimensional layer 400 having a plurality of perceptrons 402 constructed in accordance with the present disclosure. The multidimensional layer 400 having the plurality of perceptrons 402, constructed in accordance with the modular perceptron 50 (or the conditional perceptron 100), enables generation of neural networks within hardware (e.g., within FPGAs) that are separated from a set of static weights (e.g., scalar vectors 406) and inputs (e.g., input vectors 407), thereby allowing the neural networks to be trained and pruned as necessary. The multidimensional layer 400 of FIG. 5 shows generated convolutional layers 404 with subsampling, linear layers, and pooling layer tree structures, which, in some embodiments, may be arranged into multiple neural network structures, including LeNet5.

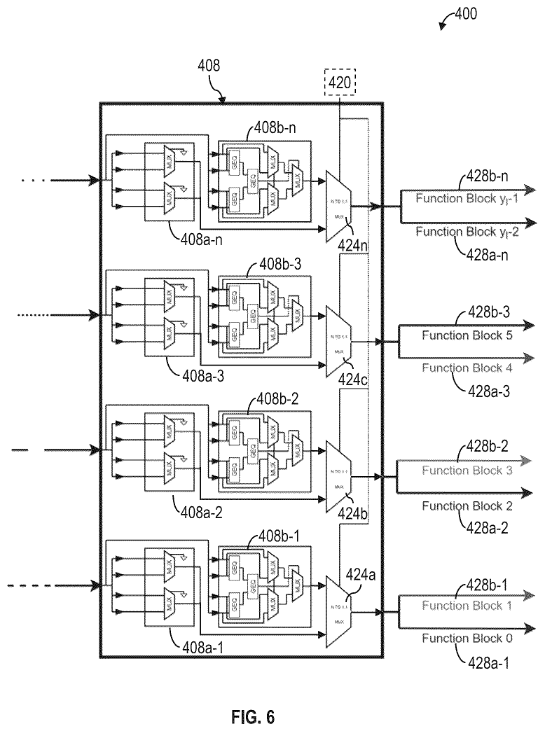

In one embodiment, the multidimensional layer 400 may be constructed similarly to the linear layer 300, but may further comprise one or more window function 408 (further shown in FIG. 6) for connecting to subsequent layers of the neural network. The window functions 408 may function similarly to the scalar vectors 320 of the linear layer 300 shown in FIG. 4, however, the window function 408 may further conditionally prune the layer output 412.

In one embodiment, the window functions 408 may be large and directly produce the layer output 412, or may make use of a sliding pattern with a smaller window function used to produce outputs as the window is offset across the multidimensional layer 400, as used in convolutional layers shown in FIG. 5. As shown, a first perceptron 402a and a second perceptron 402b are shown without connections 416 to any of the window functions 408, and may therefore by pruned/removed. Each of the windows functions 408 may be subsampled based on a window function selector 420 comprising select functions 422. The select functions 422 of the window function selector 420 may be used to choose between different window functions 408 used simultaneously for different purposes by a layers 404 of the perceptrons 402.

In one embodiment, the window functions 408 may comprise a subsampling layer implemented as a binary tree of an arbitrary function, connected directly to outputs of the multidimensional layer 400, for example, to limit a number of perceptrons per multidimensional layer 400. The subsampling layers are provided a subvector (e.g., a subset of perceptron output vectors) of a previous output layer on which to execute the arbitrary function.

In some embodiments, the subsampling layers act as pooling layers, where either the average, minimum, maximum (or other criteria) is given for all subvector inputs. In hardware, finding a minimum or a maximum may provide increased performance over finding an average. Therefore, in some embodiments, the arbitrary function may be a minimum or maximum function.

Referring now to FIG. 6, shown therein is a functional diagram of exemplary embodiments of the window function 408 of FIG. 5 constructed in accordance with the present disclosure. A first window function 408a is shown as a convolution window function and a second window function 408b is shown as a maxpool window function, however, the first window function 408a and the second window function 408b are not limited to the convolution window function and the maxpool window function, and may include other types of window functions. As shown, output vectors from the convolutional layer 404 are provided to each window function 408a-1 to 408a-n and 408b-1 to 408b-n. Signals from the window function selector 420 may select a window output from one or more of the first window function 408a-n and the second window function 408b-n and provide the selected window output as a multiplexor output by controlling each multiplexor 424a-n (e.g., via the window function selector 420). In some embodiments, the multiplexor output for each multiplexor 424a-n may be (optionally) broken into function block 428a, 428b denoted by a function size, e.g., for synthesis, to keep vector size usable.

### Experimental Results

While the description below includes disclosure of inventive concept(s) in conjunction with the specific experimentation, results, and language, it is evident that many alternatives, modifications, and variations will be apparent to those skilled in the art. Accordingly, it is intended to embrace all such alternatives, modifications, and variations that fall within the spirit and broad scope of the present disclosure.

The modular perceptron 50 and the conditional perceptron 100 disclosed herein enable generation of hardware layers and, thus, creation of RTL (Register Transfer Level) hardware for LeNet5. LeNet5 was implemented as a network model in TensorFlow™, and a string of layer information was linted from the resulting python output of the TensorFlow model. The trained weight vectors (e.g., weight vectors 60b) and input vectors (e.g., input vectors 60a) were examined from the TensorFlow™ network model to prune unnecessary nodes from the network model to generate the plurality of layers for synthesis. A two-dimensional convolutional layer (e.g., an implementation of the multidimensional layer 400) was generated, followed by the subsampling layer with a corresponding convolutional window function 408. A maxpool layer followed the subsampling layer to adjust the size of the multidimensional layer 400 to a three-dimensional convolutional layer 404. This was followed by a subsampling and maxpool layer structure that was similar to that of the previous convolutional layer. The output of the second pooling layer was fed into three linear layers (e.g., multiples of the linear layer 300 as described above), decreasing in size down to ten (10) classification outputs. Depending on the state of the weights taken from the TensorFlow™ network model, the size and speed of the neural network greatly varies due to the amount of pruning achieved.

Hardware architectures were implemented using RTL-compliant System Verilog and were synthesized using a 32 nm Global Foundries™ technology using ARM MTCMOS standard cells. Synthesis was optimized for delay utilizing Synopsys® (SNPS) Design Compiler™ (DC) in topographical mode using a PVT process at 25° C. using TT corners. Topographical synthesis, provided by Synopsys® DC™ (DC) ensures synthesis that accurately predicts timing, area and power by including information from the standard-cell layouts and underlying interconnect. The average fanout-of-4 (FO4) delay measured with SPICE is measured to be 5.95 ns. Tables I and II show the post-synthesis results for the presently disclosed technology using the Synopsys® DC™ synthesis software. Software networks are implemented as well using TensorFlow™ and PyTorch™, and network execution performance is measure on an Nvidia A100 accelerator card. The A100 platform was using NVIDIA-SMI driver version 530.30.02 and CUDA 12.1. TensorFlow™ version 2.10.0 and PyTorch™ version 2.0.1 were used.

Results are provided for the synthesis of individual perceptrons (e.g., the modular perceptron 50 or the conditional perceptron 100) in Table I (showing post-synthesis and software performance results for individual perceptrons). These results show the performance of individual perceptrons as the perceptrons are scaled in size. All perceptrons are kept to a bit-width of 16 and are varied by the number of inputs used.

| | | Area | Delay | Power [mW] | | | |
|---|---|---|---|---|---|---|---|
| Perceptron Type | # Cells | [um2] | [ps/FO4] | Internal | Switching | Leakage | Total |
| 32-input 16-bit | 2,333 | 2,703 | 206.2/34.66 | 469.1 | 112.8 | 0.426 | 582.3 |
| 64-input 16-bit | 3,256 | 4,050 | 230.7/38.77 | 484.0 | 101.9 | 0.635 | 586.6 |
| 128-input 16-bit | 5,575 | 6,315 | 247.9/41.66 | 582.0 | 149.2 | 0.971 | 732.2 |
| 256-input 16-bit | 10,286 | 11,058 | 280.2/47.09 | 703.8 | 224.5 | 1.838 | 928.3 |

Results are also provided for LeNet5 implemented using the modular perceptron 50 (shown in FIG. 2). Due to size and memory limitations present in Design Compiler™, the design needed to be synthesized over multiple runs. The results provided are from the aggregate of the necessary runs across each subsection of the generated RTL networks. Weight values of different sparsity levels were used when generating LeNet5 to act as analogs to software implementations with and without significant pruning. These results are compared against the same network implementation achieved in both TensorFlow™ and PyTorch™.

| | | | Total | | | | | |
|---|---|---|---|---|---|---|---|---|
| LeNet5 | | Area | Datapath | Power [mW] | | | | PDP |
| Implementation | # Cells | [um2] | Delay [ns] | Internal | Switching | Leakage | Total | [uJ] |
| RTL Gen. 90% | 2,104e+3 | 1.360 | 90.43 | 348.3 | 77.90 | 1.329 | 426.8 | 38.59 |
| Sparsity | | | | | | | | |
| RTL Gen. 50% | 18,153e+3 | 20.31 | 329.1 | 1.862e+3 | 750.4 | 8.013 | 2.471e+3 | 813.2 |
| Sparsity | | | | | | | | |
| PyTorch ™ | — | — | 129.9e+3 | — | — | — | 300.0 | 38.97e+3 |
| (Nvidia A100) | | | | | | | | |
| TensorFlow ™ | — | — | 183.3e+3 | — | — | — | 300.0 | 54.99e+3 |
| (Nvidia A100) | | | | | | | | |

Analyzing the performance results from Table I, as shown, there is a positive correlation between the input size and a number of parameters. Namely, the number of cells, the area of each perceptron, as well as the power consumption are all proportional to the number of inputs given to a perceptron. However, since the critical path of the perceptron is determined by the datapath from the multiplier through the activation function, the delay performance stays consistent regardless of the number of inputs provided. The delay performance ranges from 206.2 ps to 280.2 ps. The number of standard cells, as well as the area, vary greatly. The range for the number of cells is 2,333 to 10,286 and the range of the consumed area is 2,703 to 11,058 μm². The results for power consumption also follow this pattern, with 32-input perceptrons consuming 582.3 mW and 256-input perceptrons consuming 928.3 mW. It should be noted that the non-combinational power consumption of the design is more significant until the number of inputs reaches greater than 64. This is why the power consumption difference between 32-input and 64-input perceptrons is not very large.

Analyzing the performance results from Table II, as shown, RTL generated (i.e., hardware implemented) networks have significant performance advantages of software implementations, especially in terms of delay. However, unless the generated network is kept especially sparse, the power consumption of the network becomes unreasonable. Even with sparse weights provided, the power consumption of a given RTL generated network is very large. This high power consumption is outweighed by the delay performance benefits given from RTL networks. The power-delay-product (PDP) for RTL networks are orders of magnitude lower than software implementations. LeNet5 generated with 90% sparse weights can achieve a PDP of 38.59 uJ, while a PyTorch™ implementation has a PDP of 38,970 uJ, using the Nvidia A100's 300 W TDP as a power reference.

Further, the above experimentation shows that synthetization of a given RTL network as a hardware device (such as in an FPGA) and properly powering it, will result in extremely fast execution of a neural network compared to a software-implemented counterpart. Such an RTL network would likely be similar in size to, or smaller than, LeNet5 with significant weight pruning available. In some embodiments, small numbers of modular perceptrons 50 could be synthesized along with traditional hardware used to execute software networks for situational delay performance improvements.

Turning now to the inventive concept(s), certain illustrative but non-limiting embodiments thereof are described in the attached disclosures. While the attached disclosures describe the inventive concept(s) in conjunction with the specific drawings, experimentation, results, and language set forth hereinafter, it is evident that many alternatives, modifications, and variations will be apparent to those skilled in the art. Accordingly, it is intended to embrace all such alternatives, modifications, and variations that fall within the spirit and broad scope of the present disclosure.

### ILLUSTRATIVE CLAUSES

Exemplary, non-limiting Clauses are provided herein below. However, the scope of the present inventive concept(s) is to be understood to not be limited in any manner by the Clauses presented below.

Clause 1. A modular perceptron, comprising:
a first n-input wide multiplexor operable to receive an n-input wide numeric vector having multiple input values and operable to select a particular input value of the multiple input values of the n-input wide numeric vector;
a second n-input wide multiplexor operable to receive an n-input wide weight vector having multiple weight input values and operable to select a particular weight value of the multiple weight input values of the n-input wide weight vector;
a first register operable to receive the particular numerical value from the first n-input wide multiplexor;
a second register operable to receive the particular weight value from the second n-input wide multiplexor;
a numerical and weight multiplier operable to perform a multiplication operation on the particular numerical value and the particular weight value to generate a product signal;
a first multiplexor operable to receive the product and select between the product signal and zero as a first output;
a counter operable to iterate on a scale of 1 from 0 to n−1 to generate a counter value;
a second multiplexor operable to select between the counter value and zero as a second output;
a counter logic circuitry configured to receive a global reset, to send the counter value to the first multiplexor to cause the first n-input wide multiplexor to select the particular input value; to send the counter value to the second multiplexor to cause the second n-input wide multiplexor to select the particular weight value, to selectively send a first reset value to the first multiplexor; to selectively send a second reset value to the second multiplexor; and to send the counter value to the counter to cause the counter to iterate;
a product and linear combination adder operable to generate a sum output based on the first output of the first multiplexor and a third output of a third multiplexor;
a third register operable to store the sum output of the product and linear combination adder and generate a sum output signal;
the third multiplexor operable to receive the sum output signal from the third register, to select between the sum output signal and zero as a selected value, and to send the selected value to the product and linear combination adder as the third output;
a non-linear activation function circuitry coupled to the third register and operable to receive the sum output signal and to generate an activation output;
a fourth register operable to receive the activation output from the non-linear activation function circuitry and generate a perceptron output;
a base clock circuitry configured to generate a base clock signal having a first frequency, the base clock signal being provided to the fourth register; and
a sub clock circuitry configured to generate a sub clock signal having a second frequency within a range from n-times higher than the first frequency to an upper value based on a critical propagation delay between an input of the numerical and weight multiplier to the sum output of the product and linear combination adder, the sub clock signal being provided to the first register, the second register, and the third register.

Clause 2. The modular perceptron of Clause 1, further comprising one or more numerical register, wherein the first n-input wide multiplexor is further operable to receive the n-input wide numeric vector from the one or more numerical register.

Clause 3. The modular perceptron of any one of Clauses 1-2, further comprising one or more weight register, wherein the second n-input wide multiplexor is further operable to receive the n-input wide weight vector from the one or more weight register.

Clause 4. The modular perceptron of any one of Clauses 1-3, wherein the numerical and weight multiplier is a combinational multiplier circuitry.

Clause 5. The modular perceptron of any one of Clauses 1-4, wherein the numerical and weight multiplier is a sequential multiplier and the sub clock circuitry is a first sub clock circuitry configured to generate a first sub clock signal, the modular perceptron further comprising:
a second sub clock circuitry configured to generate a second sub clock signal having a third frequency within a range having a lower value selected from the greater of the first frequency and the second frequency and an upper value based on a critical propagation delay between the input of the sequential multiplier to the sum output of the product and linear combination adder;
wherein the first sub clock circuitry is further configured to generate the first sub clock signal having the second frequency within the range having the upper value of the third frequency divided by (2*m/l) times, wherein m is a bit width of an output of the first register or the second register, and l is a number of bits the sequential multiplier correctly generates per cycle.

Clause 6. The modular perceptron of any one of Clauses 1-5, wherein the sum output and the product signal have a predetermined format.

Clause 7. The modular perceptron of Clause 6, wherein the predetermined format is one of Posit, bfloat16, fixed-point, and IEEE754.

Clause 8. The modular perceptron of Clause 6, wherein the product and linear combination adder has an architecture comprising one of an RCA, carry-skip, carry-select, prefix-tree, and carry-look ahead.

Clause 9. The modular perceptron of any one of Clauses 1-8, wherein the non-linear activation function circuitry is a rectified linear unit.

Clause 10. The modular perceptron of any one of Clauses 1-9, wherein the sub clock circuitry is a first sub clock circuitry, and further comprising an output register operable to receive the perceptron output of the fourth register; and a second sub clock circuitry configured to generate a second sub clock signal having a third frequency less than the first frequency.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A modular perceptron, comprising:
a first n-input wide multiplexor operable to receive an n-input wide numeric vector having multiple input values and operable to select a particular input value of the multiple input values of the n-input wide numeric vector;
a second n-input wide multiplexor operable to receive an n-input wide weight vector having multiple weight input values and operable to select a particular weight value of the multiple weight input values of the n-input wide weight vector;
a first register operable to receive the particular numerical value from the first n-input wide multiplexor;
a second register operable to receive the particular weight value from the second n-input wide multiplexor;
a numerical and weight multiplier operable to perform a multiplication operation on the particular numerical value and the particular weight value to generate a product signal;
a first multiplexor operable to receive the product and select between the product signal and zero as a first output;
a counter operable to iterate on a scale of 1 from 0 to n−1 to generate a counter value;
a second multiplexor operable to select between the counter value and zero as a second output;
a counter logic circuitry configured to receive a global reset, to send the counter value to the first multiplexor to cause the first n-input wide multiplexor to select the particular input value; to send the counter value to the second multiplexor to cause the second n-input wide multiplexor to select the particular weight value, to selectively send a first reset value to the first multiplexor; to selectively send a second reset value to the second multiplexor; and to send the counter value to the counter to cause the counter to iterate;
a product and linear combination adder operable to generate a sum output based on the first output of the first multiplexor and a third output of a third multiplexor;
a third register operable to store the sum output of the product and linear combination adder and generate a sum output signal;
the third multiplexor operable to receive the sum output signal from the third register, to select between the sum output signal and zero as a selected value, and to send the selected value to the product and linear combination adder as the third output;
a non-linear activation function circuitry coupled to the third register and operable to receive the sum output signal and to generate an activation output;
a fourth register operable to receive the activation output from the non-linear activation function circuitry and generate a perceptron output;
a base clock circuitry configured to generate a base clock signal having a first frequency, the base clock signal being provided to the fourth register; and
a sub clock circuitry configured to generate a sub clock signal having a second frequency within a range from n-times higher than the first frequency to an upper value based on a critical propagation delay between an input of the numerical and weight multiplier to the sum output of the product and linear combination adder, the sub clock signal being provided to the first register, the second register, and the third register.

2. The modular perceptron of claim 1, further comprising one or more numerical register, wherein the first n-input wide multiplexor is further operable to receive the n-input wide numeric vector from the one or more numerical register.

3. The modular perceptron of claim 1, further comprising one or more weight register, wherein the second n-input wide multiplexor is further operable to receive the n-input wide weight vector from the one or more weight register.

4. The modular perceptron of claim 1, wherein the numerical and weight multiplier is a combinational multiplier circuitry.

5. The modular perceptron of claim 1, wherein the numerical and weight multiplier is a sequential multiplier and the sub clock circuitry is a first sub clock circuitry configured to generate a first sub clock signal, the modular perceptron further comprising:
a second sub clock circuitry configured to generate a second sub clock signal having a third frequency within a range having a lower value selected from the greater of the first frequency and the second frequency and an upper value based on a critical propagation delay between the input of the sequential multiplier to the sum output of the product and linear combination adder;
wherein the first sub clock circuitry is further configured to generate the first sub clock signal having the second frequency within the range having the upper value of the third frequency divided by (2*m/l) times, wherein m is a bit width of an output of the first register or the second register, and l is a number of bits the sequential multiplier correctly generates per cycle.

6. The modular perceptron of claim 1, wherein the sum output and the product signal have a predetermined format.

7. The modular perceptron of claim 6, wherein the predetermined format is one of Posit, bfloat16, fixed-point, and IEEE754.

8. The modular perceptron of claim 6, wherein the product and linear combination adder has an architecture comprising one of an RCA, carry-skip, carry-select, prefix-tree, and carry-look ahead.

9. The modular perceptron of claim 1, wherein the non-linear activation function circuitry is a rectified linear unit.

10. The modular perceptron of claim 1, wherein the sub clock circuitry is a first sub clock circuitry, and further comprising an output register operable to receive the perceptron output of the fourth register; and a second sub clock circuitry configured to generate a second sub clock signal having a third frequency less than the first frequency.
